(19) United States
(12) Patent Application Publication
(10) Pub. No.: US 2007/0000907 A1
(43) Pub. Date: Jan. 4, 2007

(54) FUEL-BASED TOOL WITH SENSORS

(76) Inventor: Arlo Lin, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/306,579

(22) Filed: Jan. 3, 2006

(30) Foreign Application Priority Data
May 18, 2005 (TW) 94116196

(51) Int. Cl. H05B 1/02

(52) U.S. Cl. 219/494

(57) ABSTRACT

A fuel-based tool includes a shell, a switch installed on the shell, a sensing device provided in the shell so as to detect at least one factor related to the operation of the fuel-based tool and a display installed on the shell and connected to the sensing device so as to show the factor.

### BACKGROUND OF INVENTION

1. Field of Invention

The present invention relates to a fuel-based tool with sensors.

2. Related Prior Art

Disclosed in Taiwanese Patent Publication No. 572813 is an electric tool with additional functions. The conventional electric tool includes a shell 1 formed with a handle 2. A battery pack 3 is attached to the handle 2 by means of a latch 4. Installed on the handle 2 is a trigger 5 operable for turning on and off a tool bit 7 such as a screwdriver bit and a drill bit. In an aspect, installed on the battery pack 3 is a radio including on and off buttons 9, volume buttons 10 and tuner buttons 11 and a speaker 12. In an alternative aspect, installed on the battery pack 3 is a clock 14. In an alternative aspect, installed on the battery pack 3 is a display 19. In practice, several battery packs are needed. One is in use while the others are spare. As time passes, such battery packs will store less electricity and must be replaced with new ones. Therefore, such battery packs must be inexpensive. However, the addition of the radio, the clock 14 or the display 19 to the battery pack 3 increases the cost inevitably. Moreover, the radio, the clock 14 and the display 19 are not essential for the operation of the electric tool. Furthermore, such battery packs discharge even when they are not in use, and often fail to provide adequate electricity when they come to use.

The present invention is intended to obviate or at least alleviate the problems encountered in prior art.

### SUMMARY OF INVENTION

According to the present invention, a fuel-based tool includes a shell, a switch installed on the shell, a sensing device provided in the shell so as to detect at least one factor related to the operation of the fuel-based tool and a display installed on the shell and connected to the sensing device so as to show the factor.

An advantage of the fuel-based tool of the present invention is its low cost since the sensing device is positioned in the shell instead of attached to a battery that has to be replaced with a new one.

Another advantage of the fuel-based tool of the present invention is that the sensing device and the display provide essential information related to the operation of the fuel-based tool.

Other advantages and features of the present invention will become apparent from the following description referring to the drawings.

### BRIEF DESCRIPTION OF DRAWINGS

The present invention will be described through detailed illustration of three embodiments referring to the drawings.

FIG. 1 is a cross-sectional view of a fuel-based tool according to the first embodiment of the present invention.

FIG. 2 is a block diagram of an electric device used in the fuel-based tool shown in FIG. 1.

FIG. 3 is a side view of a fuel-based tool according to the second embodiment of the present invention.

FIG. 4 is a perspective view of a fuel-based tool according to the third embodiment of the present invention.

### DETAILED DESCRIPTION OF EMBODIMENTS

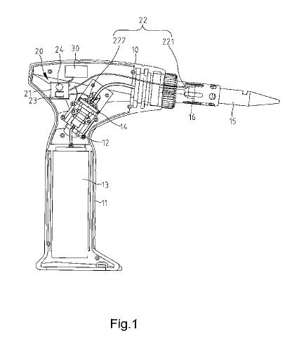

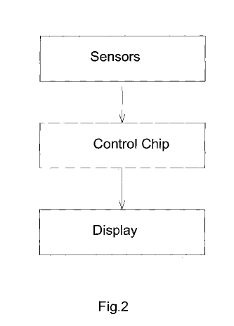

Referring to FIGS. 1 and 2, there is shown a fuel-based tool according to a first embodiment of the present invention. The fuel-based tool includes a shell 10, a sensing device 20 and a display 30. The sensing device 20 is positioned in the shell 10 so as to detect various factors of the fuel-based tool. The display 30 is installed on the shell 10 so as to provide users with information related to the fuel-based tool.

The shell 10 includes a handle 11. A switch 12 is installed on the handle 11. A fuel can 13 is positioned in the handle 11. A valve 14 is connected to the fuel can 13. A combustor 16 is connected to the valve 14. A working bit such as a soldering tip 15 is connected to the combustor 16.

The sensing device 20 includes a circuit board 21 and a sensor set 22 connected to the circuit board 21. The circuit board 21 includes a control chip 23 and a battery 24 both installed thereon. The control chip 23 receives signals from the sensor set 22. The battery 24 provides electricity to the circuit board 21. The control chip 23 detects the voltage provided to the circuit board 21 from the battery 24. The sensor set 22 includes a thermometer 221 and a flow rate sensor 222. The thermometer 221 is positioned on the combustor 16 so as to take the temperature of the combustor 16. The flow rate sensor 222 is positioned on the valve 14 so as to detect the flow rate of fuel going through the valve 14.

The display 30 is connected to the circuit board 21. Under the control of the control chip 23, the display 30 shows the temperature, the flow rate and the voltage. If the temperature is too high, the fuel-based tool is stopped. If the flow rate is too low, the fuel can 13 is refilled. If the flow rate is too high, there is a possibility that there is leakage. It would be better to stop to check the fuel-based tool. If the voltage is too low, the battery 24 is replaced with a new one.

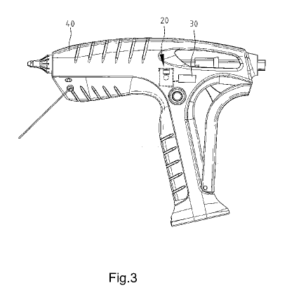

Referring to FIG. 3, there is shown a fuel-based tool according to a second embodiment of the present invention. The second embodiment is a glue distributor 40.

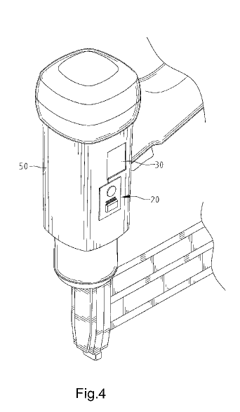

Referring to FIG. 4, there is shown a fuel-based tool according to a third embodiment of the present invention. The second embodiment is nail distributor 50.

The fuel-based tool of the present invention exhibits several advantages. Firstly, its cost is low since the sensing device is positioned in the shell instead of attached to a battery has to be replaced with a new one. Secondly, the sensing device and the display provide essential information related to the operation of the fuel-based tool. Thirdly, the fuel-based tool can be embodied in various manners.

The present invention has been described through the illustration of the embodiments. Those skilled in the art can derive variations from the embodiments without departing from the scope of the present invention. Therefore, the embodiments shall not limit the scope of the present invention defined in the claims.

What is claimed is:

1. A fuel-based tool comprising:
a shell;
a switch installed on the shell;
a sensing device provided in the shell so as to detect at least one factor related to the operation of the fuel-based tool; and
a display installed on the shell and connected to the sensing device so as to show the factor.

2. The fuel-based tool according to claim 1 comprising a fuel can positioned in the shell, a valve installed on the fuel can and a combustor connected to the valve.

3. The fuel-based tool according to claim 2 wherein the sensing device comprises at least one sensor.

4. The fuel-based tool according to claim 3 wherein the sensor is a flow rate sensor installed on the valve.

5. The fuel-based tool according to claim 3 wherein the sensor is a thermometer installed on the combustor.

6. The fuel-based tool according to claim 3 wherein the sensing device comprises a circuit board connected to the sensor.

7. The fuel-based tool according to claim 6 wherein the sensing device comprises a control chip installed on the circuit board so as to control the sensor and the display.

8. The fuel-based tool according to claim 6 wherein the sensing device comprises a battery installed on the circuit board.

9. The fuel-based tool according to claim 2 wherein the sensing device comprises a sensor set.

10. The fuel-based tool according to claim 9 wherein the sensing device comprises a circuit board connected to the sensor set.

11. The fuel-based tool according to claim 10 wherein the sensing device comprises a control chip installed on the circuit board so as to control the sensor set and the display.

12. The fuel-based tool according to claim 10 wherein the sensing device comprises a battery installed on the circuit board.

13. The fuel-based tool according to claim 9 wherein the sensor set comprises a flow rate sensor installed on the valve and a thermometer installed on the combustor.

14. The fuel-based tool according to claim 2 comprising a tool bit connected to the combustor.

15. The fuel-based tool according to claim 14 wherein the tool bit is a soldering bit.

16. The fuel-based tool according to claim 1 wherein the fuel-based tool is a glue distributor.

17. The fuel-based tool according to claim 1 wherein the fuel-based tool is a nail distributor.

18. The fuel-based tool according to claim 1 wherein the shell comprises a handle.

19. The fuel-based tool according to claim 18 comprising a switch installed on the handle.
